(19) United States
(12) Patent Application Publication
(10) Pub. No.: US 2006/0229958 A1
(43) Pub. Date: Oct. 12, 2006

(54) System, method, and computer program product for reconciling financial data from multiple sources

(76) Inventors: Anthony Sergio, Mansfield, TX (US); John Hanson, Flower Mound, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/100,035

(22) Filed: Apr. 6, 2005

(51) Int. Cl. G07F 19/00; G06Q 40/00; G07B 17/00

(52) U.S. Cl. 705/35; 705/30

(57) ABSTRACT

A system, method, and computer program product are provided that receive financial data from different sources, parse the financial data using a rules engine such that it can be combined, add first and second data keys such that the data entries can be reconciled, reconcile the combined data, and output the reconciled data to a general ledger. In this regard, financial data related to various aspects of reselling products and services can be quickly and efficiently combined and reconciled.

### FIELD OF THE INVENTION

The present invention relates generally to formatting and reconciling financial data, and more particularly, to systems, methods, and computer program products for reconciling financial data from multiple sources relating to the purchase and sale of products and services via an intermediary.

### BACKGROUND OF THE INVENTION

Many products and services that are sold through remote channels, such as websites or telephone call centers, are sold through intermediaries. Intermediaries are companies that sell products made by other companies or services performed by other companies. These intermediaries are also called resellers. One common example of an intermediary is a travel services seller, such as Travelocity, Expedia, and Orbitz. These travel services sellers provide a single place for a customer to purchase travel services offered and provided by a variety of travel service providers. For example, a customer may desire to take a vacation and may therefore purchase an airline ticket, secure a hotel reservation, and secure a rental car reservation from one of these travel services sellers. The airline flight, the hotel room, and the rental car would typically be provided by three separate companies. A customer might arrange for only one service at a time with the intermediary (e.g., a hotel room at a destination to which the customer is driving), or the customer might arrange an entire vacation such that the services of three or more service providers may be secured at one time (e.g., airline ticket, hotel room, rental car, concert tickets, ski lift tickets, and meal vouchers).

There may be many different business models by which these intermediaries operate. Two such models may be called the commission model and the merchant model. In the commission model, the intermediary assists the customer in securing services from one or more service providers, but the service providers receive payment for the services directly from the customer. As such, the service providers are the merchants of record for the purchases of their respective services. The intermediary would typically receive a commission, that is, a percentage of the fee charged to the customer, from the service provider.

In the merchant model, the intermediary purchases services from the service provider and sells the services to the customer. The intermediary would typically charge a price to the customer for the service that is higher than the price the intermediary must pay to the service provider, such that the intermediary makes a profit on the sale. In this model, the intermediary receives payment for the services directly from the customer, and the intermediary pays the service provider for the services. As such, the intermediary is the merchant of record for all the purchases made by the customer.

In either model, when a service is sold to a customer, the intermediary typically secures the services of a service provider by entering the order into a booking system. The booking system is typically interfaced with the intermediary's website or ordering system. When an order is received from a customer, the details of the order, including the specific service provider, the requested date of service, and any other information required for the service provider to be able to provide the service, is transmitted to the booking system. The intermediary's booking system may be accessed by the service provider, either automatically or manually, such that the service provider learns of the order.

In addition to securing the requested services for the customer, as the merchant of record the intermediary generally also performs several financial transactions. The intermediary processes the customer's payment for the services. This typically involves posting a credit card charge to a credit card provider, but may involve other payment methods as well. The intermediary typically receives payment authorization immediately from the credit card provider, and receives a settlement statement and payment from the credit card provider at a later date. The intermediary receives invoices or bills from the service providers for the service provided to the customer. These invoices are processed and payment is sent to the service provider. The intermediary may use an alternate method of paying the service provider. For example, the intermediary may use what is termed a single-use or disposable credit card number. A single-use credit card number is a credit card number that can be used to make one purchase and that is linked to a valid credit card account. If the intermediary uses a single-use credit card number to pay the service providers, then the intermediary will typically receive a statement from the single-use credit card number provider confirming the payment to the service provider.

Payments received from customers and payments made to service providers are typically entered into a general ledger that tracks all the financial transactions of the company. Many companies use a computer-based general ledger software program, such as may be provided by SAP or PeopleSoft. If so, the financial transactions must be formatted consistently and in the manner required by the general ledger software program. Formatting the financial data consistently and correctly may be difficult and time-consuming. The financial data may be entered manually into the general ledger software, for example as a result of paper invoices received from service providers. The financial data may be received electronically by the intermediary, such as in a comma-delimited text file sent from the service provider using File Transfer Protocol (FTP). The financial data may also be received in a series of separate electronic messages using the extensible markup language (XML) format, with each XML message containing the financial data for a single transaction. Where the financial data is received electronically, it may not be in the proper format required by the general ledger software, and may need to be reformatted. For an intermediary that processes a large number of orders from a large number of customers, this reformatting is particularly time-consuming. This is especially true because the intermediary may have to format financial data coming from four or more different sources, with each of the sources using having different formats for corresponding data. Where the financial data is received as an XML message, the XML message would typically need to be parsed to extract the financial data from the XML message such that the data can be combined into the summary data table.

After formatting this financial data but prior to entering it into the general ledger, an intermediary may desire to reconcile, or match, the data. Reconciling the data may be done to ensure that payments are received from all customers who have made purchases, and to ensure that all invoices received from or payments made to service providers are for services actually provided. Additionally, the dollar amount of the payments from customers and the invoices from or payments to service providers may be verified to ensure the correct amount of money is received or paid. For an intermediary that is selling travel services, this reconciliation may be complex and time-consuming. This is because financial data relating to one customer transaction may need to be reconciled with financial data relating to transactions with several service providers.

Additionally, three-way or even four-way reconciliation may need to be performed. The details of the services purchased, such as the specific services providers for the services purchased and the prices for each service, may be retrieved from the intermediary's ordering system. The details of the services secured, such as the total price of the service to the customer and the cost of the service to the intermediary, may be retrieved from the booking system. The details of the customer payments posted to and settled by the credit card company may be received from the credit card company. The details of the payments made to the service providers may be received from the single-use credit card number provider. The intermediary may desire to reconcile the financial data from these four different sources. This four-way reconciliation ensures that all of the services purchased by the customer are paid for by the customer, and the invoices received from the service providers are only for services actually purchased by the customer and provided by the service provider. This need for three-way or four-way reconciliation, combined with the need to reconcile one customer transaction with multiple service provider transactions, makes the task of reconciling financial data particularly difficult for a travel services sellers.

The financial reconciliation is further complicated by the variety of service providers whose services the intermediary sells. Orders for one service provider's services may be handled differently than that of another service provider. For example, orders for a hotel room reservation may be handled as discussed above, such that the payment is made to the hotel using a single-use credit card number, and the single-use credit card provider sends a statement to the intermediary that can be reconciled with the order information from the intermediary's website and the payment received from the customer. However, orders for air travel insurance may be handled differently. The insurance provider may not send an invoice to the intermediary, and the intermediary may pay the insurance provider based only upon the order from the customer. In such a situation, it may therefore only be possible to perform a two-way reconciliation (i.e., the order information from the intermediary's website against the payment received from the customer). Therefore, when the intermediary is reconciling financial data, it must be knowledgeable of the different requirements of the various service providers and correspondingly change the method of reconciliation to accommodate the different requirements.

These limitations in the current systems may create a burden on financial systems. Specifically, when financial data from various sources having various formats is input to a financial system, the inconsistent formatting would typically prevent the financial data from processing successfully. The financial data would typically need to be manually reformatted, re-input, and reprocessed. Each time the financial data is reprocessed, it puts added burden on the financial system to process the data. In some instances, added systems may be required to be able to process financial data multiple times.

As such, there is a need for a system, method and computer program product for combining and reconciling financial data relating to the sale of products and services from a number of different providers, through an intermediary, to a number of different customers.

### BRIEF SUMMARY OF THE INVENTION

A system, method, and computer program product are therefore provided that receive financial data from different sources, parse the financial data such that it can be combined, add data keys such that the combined data can be reconciled, and output the reconciled data to a general ledger. In this regard, financial data related to various aspects of reselling products and services can be quickly and efficiently combined and reconciled.

According to the present invention, a plurality of financial data tables relating to a plurality of financial transactions are received from a plurality of different sources, with each financial data table comprising a plurality of data entries and a plurality of data field names, and each data entry comprising at least a dollar amount. Thereafter, the financial data tables are formatted such that the financial data tables are capable of being combined. A first data key value and a second data key value are then added to each data entry of each financial data table to facilitate grouping the data entries for reconciling. Thereafter, the financial data tables are combined into a summary data table comprising a plurality of data entries and a plurality of data field names. Thereafter, a first data entry and a second data entry are identified, such that the first data key value of the first data entry equals the first data key value of the second data entry, such that the second data key value of the first data entry equals the second data key value of the second data entry, and such that the dollar amount of the first data entry equals zero minus the dollar amount of the second data entry.

In one embodiment, the first data entry and the second data entry are then transmitted to a general ledger.

In one embodiment, the sources of the financial data tables include, but are not limited to, an ordering system, a booking system, a vendor payment processing system, and a customer payment processing system.

In one embodiment, the financial data tables are formatted by translating at least one of the data field names of at least one of the financial data tables using a rules engine, such that the data field names of the financial data tables match the corresponding data field names of the summary data table.

In one embodiment, the plurality of data entries of the financial data tables each have a format and the plurality of data entries of the summary data table each have a format. In this embodiment, the financial data tables are formatted by further translating at least one of the data entries of at least one of the financial data tables using the rules engine, such that the formats of the data entries of the financial data tables matches the format of the corresponding data entries of the summary data table.

In one embodiment, the first data key value is selected from a plurality of general ledger account numbers using general accounting principles and the second data key value is selected to identify one of the plurality of financial transactions.

In one embodiment, each financial data table comprises at least one credit and at least one debit related to each of the plurality of financial transactions. As such, the validity of the data may be determined by verifying that credits equal the debits.

In addition to the method for reconciling financial data described above, other aspects of the present invention are directed to corresponding systems and computer program products for reconciling financial data.

Thus the systems, methods, and computer program products for reconciling financial data from multiples sources, as described in the embodiments of the present invention, enable an intermediary business, such as a travel services seller, to combine and reconcile financial data relating to the sale of products and services from a number of different providers to a number of different customers. This advantage and others that will be evident to those skilled in the art are provided in the system, method, and computer program product of the present invention. Importantly, all of these advantages allow the system to process and reconcile financial data in an efficient manner, typically without the need to manually reformat and reprocess the financial data. As the financial data is more likely processed without manual reformatting, the financial system is less likely to be overburdened with frequent reprocessing.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flowchart of the operation of reconciling financial data relating to a plurality of financial transactions from a plurality of sources, according to one embodiment of the present invention;

FIG. 2 is an illustration of an XML message containing financial data from an ordering system, according to one embodiment of the present invention;

FIG. 3 is an illustration of a financial data table from a booking system, according to one embodiment of the present invention;

FIG. 4 is an illustration of a financial data table from a customer payment processing and settlement system, according to one embodiment of the present invention;

FIG. 5 is an illustration of a financial data table from a vendor payment processing system, according to one embodiment of the present invention;

FIG. 6 is an illustration of a summary data table created by combining the financial data tables of FIGS. 2-5 and adding data keys, according to one embodiment of the present invention;

FIG. 7 is an illustration of the summary data table of FIG. 6 after data has been reconciled, according to one embodiment of the present invention; and

FIG. 8 is a schematic block diagram of a system for reconciling financial data from a plurality of sources, according to one embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

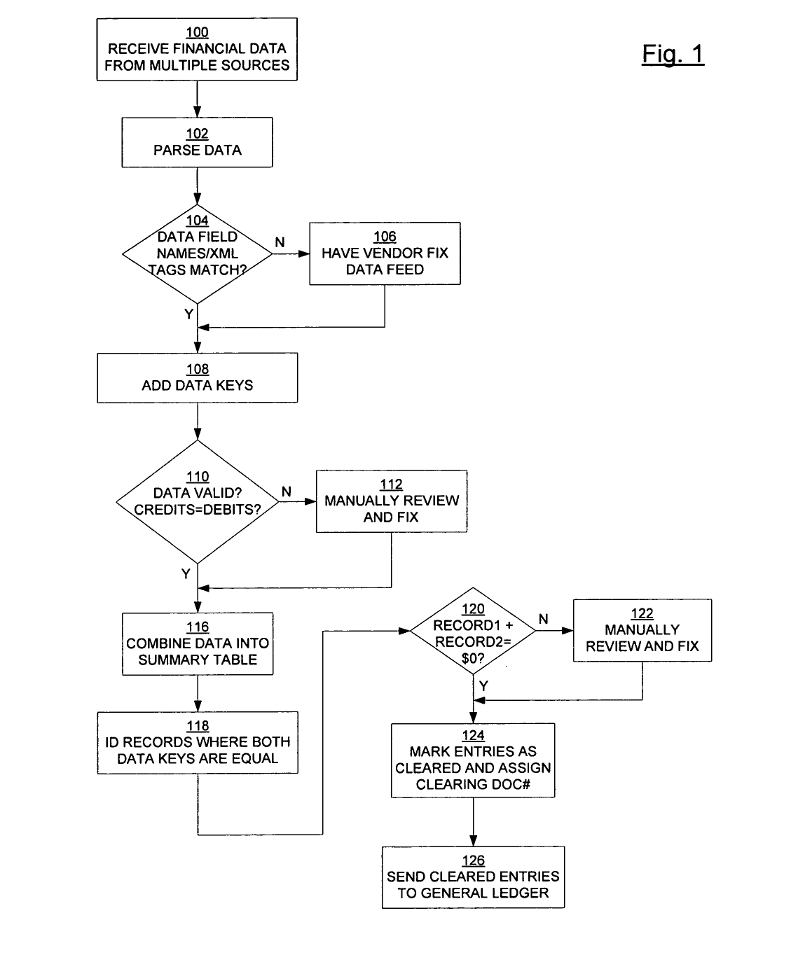

FIG. 1 is a flowchart of the operations performed by a method for reconciling financial data relating to a plurality of financial transactions from a plurality of sources, according to one embodiment of the present invention. While embodiments of the present invention will be described in terms of a system for selling travel services for purposes of explanation, it should be appreciated that the present invention may be used in any type of system where financial data from multiple sources must be combined and reconciled.

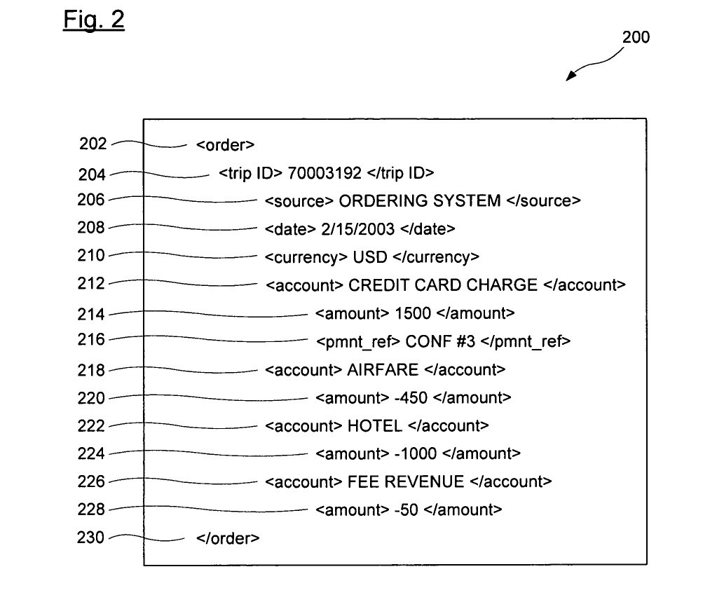

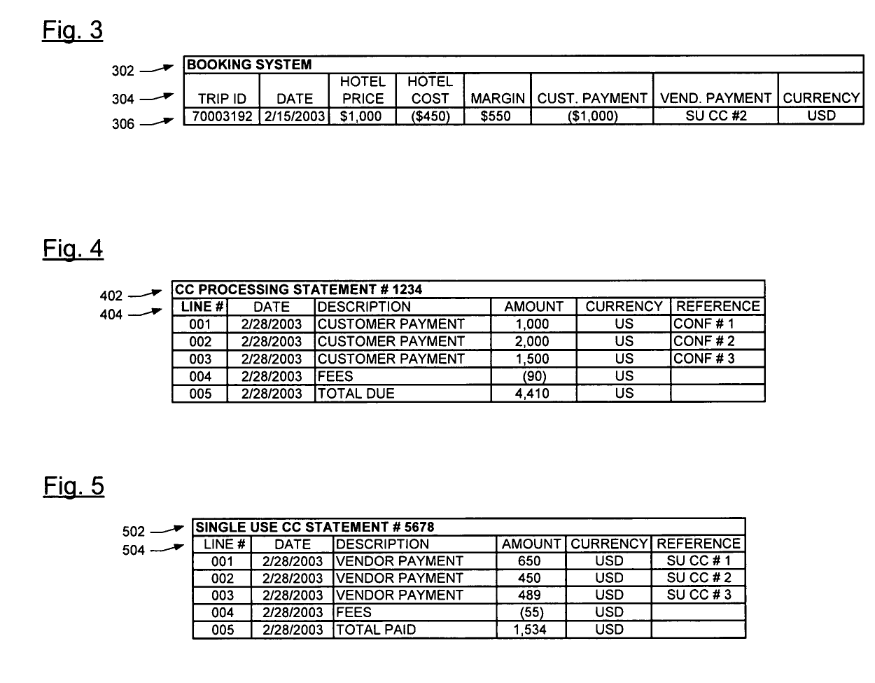

As shown in block 100 of FIG. 1, financial data is typically received from several sources. This financial data is generally in the form of tables, with each table coming from a different source. Alternatively, some of the financial data may be received in the form of XML messages. For example, in one embodiment of the invention, financial data in the form of an XML message may be received from an ordering system, such as a website, as illustrated in FIG. 2; one financial data table may be received from a booking system, as illustrated in FIG. 3; one financial data table may come from a customer payment processing system, such as a credit card processing system, as illustrated in FIG. 4; and one financial data table may be received from a vendor payment processing system, such as a single-use credit card processing system, as illustrated in FIG. 5. Each financial data table or XML message typically has a number of data entries, which are related to one or more transactions which occurred in the data source, and which are associated with data field names. For example, the financial data received from the ordering system would typically contain details of orders for travel services received from one or more customers. The financial data table received from the booking system would typically contain details of the services booked with service providers in response to the orders for travel services. The financial data table received from the vendor payment processing system would typically contain details of payments made to the service providers. The financial data table received from the credit card processing system would typically contain details of credit card payments made by the customers who placed orders for travel services. This financial data would typically be received from the sources on a periodic basis, such as once daily.

The next step generally is to parse the data to extract the financial data, as shown in step 102. Where the financial data is in an XML message, parsing the data typically involves extracting the values and/or the tags from each element of the message. Where the financial data is in a table, parsing the data typically involves extracting data field names, data field values, and table header information. The data that is extracted from each financial data table and/or XML message will typically be predefined based on the data source and the configuration of the data table and/or XML message.

Thereafter, the next step is generally to determine if the financial data tables received from the different sources in block 100 have the correct data field names, such that the data field names in the financial data tables matches the expected data field names, thereby enabling the tables to be translated and combined into the summary data table. This determination is shown in block 104 of FIG. 1. Typically, the data field names, such as “HOTEL PRICE” and “HOTEL COST” from the financial data table of FIG. 3, must be predefined for all the vendors and all financial data tables. If the data field names do not match, the vendor would typically be required to fix the data feed so that the data field names match, as shown in block 106 of FIG. 1. Alternatively, if the data field names do not match, rather than having the vendor fix the data feed, the mechanism used to translate and combine the data table could be modified to accept the different data field name.

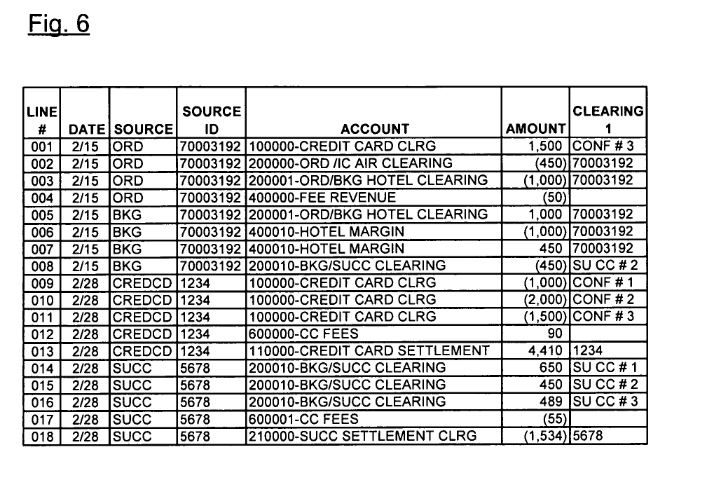

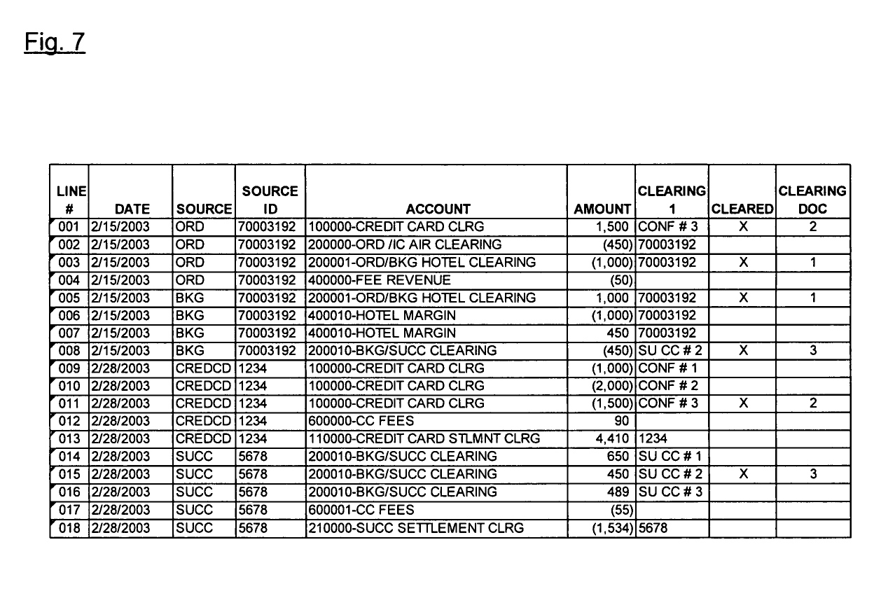

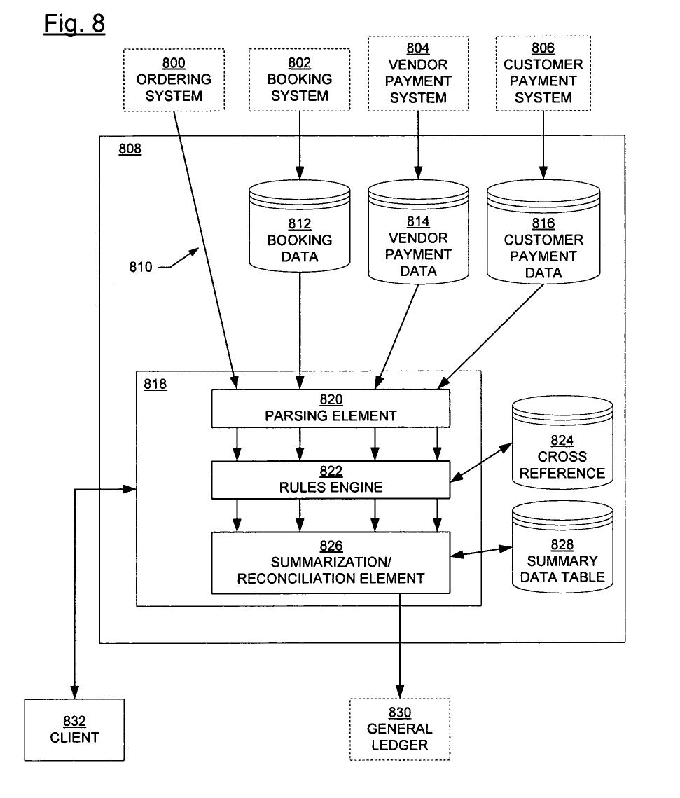

The next step generally is to add the data keys used to reconcile the data, as shown in block 108. A data key is an attribute used to sort or identify data in some way. In this embodiment of the present invention, two data keys would be added. One data key is used to identify the type of financial transaction indicated by each line of data, as indicated by a financial account value. A financial account value represents a financial classification of data that allows a business to track and reconcile financial transactions. A business would typically have a different account for each type of data that the business needs to track separately. This data key is shown in the “ACCOUNT” column of FIGS. 6 and 7. The other data key is used to identify the specific transaction to which the financial data belongs, thereby enabling data from multiple sources to be linked to a specific transaction. This data key is shown in the “CLEARING1” column of FIGS. 6 and 7. These two data keys thereby allow financial records to be reconciled against other financial records of the same type and the same transaction.

Determining what specific data keys are required may be accomplished by using a rules engine. A rules engine would typically utilize a predefined table of cross-references to indicate what data key should be added, based on the source of the data and the specific data received. These cross-references would typically be predefined for each data source. The first data key (i.e., financial account value) may be a one-for-one substitution, such that the financial account value used by the data source is changed to the financial account value used by the general ledger. For example, the data feed from a first hotel may use the financial account value “AIRFARE,” as shown in element 218 of the XML message of FIG. 2. The cross-reference table used by the rules engine would have a predefined translation, such that the financial account value “AIRFARE” in the data coming from that specific data source would be translated to “200000-ORD/IC AIR CLEARING” before being added to the summary data table. This is illustrated in line 002 of FIGS. 6 and 7. The financial account value “200000-ORD/IC AIR CLEARING” corresponds to a financial account used by the general ledger. It should be appreciated that similar data coming from a different data source than that illustrated in FIG. 2 might use a different financial account value than “AIRFARE” that might nonetheless be translated to “200000-ORD/IC AIR CLEARING.”

The second data key comprises a unique, transaction-specific identifier. The specific identifier that is used may be determined by the rules engine based on the financial account value and the data source. Some of the transaction-specific identifiers that may be used as the second data key include: (1) the trip ID, which may be assigned by the ordering system and communicated to the booking system; (2) the customer credit card payment confirmation number, which may be assigned by the ordering system and communicated to the credit card processing system; and (3) the single-use credit card number, which is assigned by the single-use credit card provider and provided by the ordering system to the booking system to provide payment for a vendor service. For example, the cross-reference table may direct the rules engine to use the customer credit card payment confirmation number as the second data key when the data source is the ordering system and the financial account value is “CREDIT CARD CHARGE.” The cross-reference table may direct the rules engine to use the trip ID as the second data key when the data source is the ordering system and the financial account value is “AIRFARE” or “HOTEL.” The cross-reference table may direct the rules engine to use the single-use credit card number as the second data key when the data source is the booking system and the financial account value is “VEND. PAYMENT.” It should be appreciated that, as the second data key is transaction-specific, the value used for the second data key for a particular data entry would be contained in the data feed containing that particular data entry, with the cross-reference table determining which value from the data feed to use. Reference will now be made to FIGS. 2 and 6 to further illustrate the above example in which the customer credit card payment confirmation number is used as the second data key when the data source is the ordering system and the financial account value is “CREDIT CARD CHARGE.” FIG. 2 is an illustration of an XML message containing financial data from an ordering system, according to one embodiment of the present invention. Line 206 of FIG. 2 indicates that the source of data is the “ORDERING SYSTEM.” FIG. 2 contains data for four different financial account value, as illustrated in lines 212, 218, 222, and 226. A credit card charge (line 212) was processed in the amount of $1500 (line 214), and a confirmation number of CONF #3 (line 216) was assigned. As the source of the data is an ordering system and the financial account value is “CREDIT CARD CHARGE,” the cross-reference table in this example would direct the rules engine to use the credit card confirmation number (“CONF #3”) as the second data key. This is illustrated in line 001 of FIG. 6, in the CLEARING 1 column. The cross-reference table directed that the second data key should be the credit card confirmation number, but the specific value (“CONF #3”) was obtained from the XML message (line 216). This is different than the first data key, whose value would typically be contained in the cross-reference table and not in the data feed.

Data entries which are profit and loss (P&L) items, such as fees and profit, are typically not reconciled and therefore do not require a second data key, although the first data key may be used to direct the P&L entry to the correct account in the general ledger. This is illustrated in lines 004, 012, and 017 of FIG. 6.

This ability to have differing cross-references to determine the appropriate data keys for each of the data feeds enables data feeds to be integrated from a plurality of data sources into the summary data table, without requiring the data source to modify the data feed to conform to the requirements of the summary data table.

The next step is generally to determine if the financial data received from the different sources in block 100 are formatted properly, such that the tables may be combined into a summary data table. This determination is shown in block 110 of FIG. 1. Several different aspects of the table format may be examined, according to the specific embodiment of the invention. For example, a date field in one of the financial data tables that is predefined to contain a dollar value may be verified to contain a numerical value. If it is determined in block 20 that the data in one of the tables is not formatted properly, then it may be reformatted manually as shown in block 112.

It may also be desirable to perform an additional check of the validity of the data. In one embodiment, the dollar amounts of each transaction may be examined to determine if the credits equal the debits, as also shown in block 110. For example, in the financial data table from the ordering system, the sum of the prices of each component of the total travel package ordered should equal the amount charged to the customer's credit card. If the credits do not equal the debits, then that may indicate some problem with the data. As such, that data would typically be queued to be manually reviewed and fixed, as shown in block 112.

After any desired checks have been performed on the financial data tables and/or XML messages, the financial data may then be combined into the summary data table, as shown in block 116. The data in the summary data table has been validated as described above. From the summary data table, the data may then be reconciled for output to the general ledger. Financial data from four different sources are illustrated in FIGS. 2-5. A summary data table is illustrated in FIG. 6. Combining the financial data tables into the summary data table typically entails extracting individual lines of data from the financial data tables, combining each individual line with certain header data from the corresponding financial data table, and entering each combined line of data into a separate line of the summary data table. As discussed above, the data field names and the formats of the data fields for all the financial data tables have been verified or corrected to match those of the summary data table, thereby enabling the data to be readily combined.

As an illustration, the financial data of FIGS. 2-5 and the first and second data keys have been combined into the summary data table of FIG. 6. The ordering data from the XML message of FIG. 2 appears in lines 001-004 of the summary data table. The booking data from the table of FIG. 3 appears in lines 005-008 of the summary data table. The customer payment data from the table of FIG. 4 appears in lines 009-013 of the summary data table. The vendor payment data from the table of FIG. 5 appears in lines 014-018 of the summary data table.

As such, lines 001-004 of the summary data table of FIG. 6 each result from two or more of the lines of financial data from the XML message in FIG. 2. For example, line 001 of FIG. 6 results from the total customer charge of $1500 in line 214 of FIG. 2 (in the “AMOUNT” column of FIG. 6), combined with the date from line 208 of FIG. 2 (in the “DATE” column of FIG. 6), the trip ID from line 204 of FIG. 2 (in the “SOURCE ID” column of FIG. 6), the data source from line 206 of FIG. 2 (in the “SOURCE” column of FIG. 6), the account from line 212 of FIG. 2 (in the “ACCOUNT” column of FIG. 6, converted to the first data key by the rules engine), and the second data key (in the “CLEARING 1” column of FIG. 6). Lines 005-008 of FIG. 6 each result from data parsed from the header (row 302), the data fields (row 304), and the data values (row 306) of the financial data table of FIG. 3. Lines 009-013 of FIG. 6 each result from data parsed from the header (row 402), the data fields (row 404), and the data values (lines 001-005) of the financial data table of FIG. 4. Lines 014-018 of FIG. 6 each result from data parsed from the header (row 502), the data fields (row 504), and the data values (lines 001-005) of the financial data table of FIG. 5.

After the various financial data tables are combined into the summary data table, the financial data may be reconciled. FIG. 7 is an illustration of the summary data table of FIG. 6 after the data has been reconciled. Reconciling financial transactions compares payments that a business believes it should receive with payments that the business actually received and compares payments that the business believes it should make with payments that the business actually made. Thus, a business can ensure that it received all payments that were due to the business, and ensure that it only made payments that were owed by the business.

The first step in reconciling the data is typically to identify those entries of the summary data table where both first data keys are the same and both second data keys are the same, as indicated in block 118 of FIG. 1. For example, in the summary data table of FIG. 7, the data entry in line 001 and the data entry in line 011 have the same first data key (i.e., “100000-CREDIT CARD CLEARING”) and the same second data key (i.e., “CONF #3”). Also, the data entry in line 003 and the data entry in line 005 have the same first data key (i.e., “200001-ORD/BKG HOTEL CLEARING”) and the same second data key (i.e., “70003192”). The data entry in line 006 and the data entry in line 007 have the same first data key (i.e., “400010-HOTEL MARGIN”) and the same second data key (i.e., “70003192”). Finally, the data entry in line 008 and the data entry in line 015 have the same first data key (i.e., “200010-BKG/SUCC CLEARING”) and the same second data key (i.e., “SU CC #2”).

After identifying the data entries with the same data keys, the next step typically is to determine if, for those data entries with the same data keys, the dollar amount (from the “AMOUNT” column) of one entry is equal to zero minus the dollar amount of another data entry with the same data keys, as indicated in block 120. For example, the data entry in line 001 of FIG. 7 has a dollar value of $1,500 and the date entry in line 011 has a dollar value of −$1,500 (negative dollar values are indicated in the tables by the parentheses). Also, the data entry in line 003 has a dollar value of −$1,000 and the date entry in line 005 has a dollar value of $1,000. Finally, the data entry in line 008 has a dollar value of −$450 and the date entry in line 015 has a dollar value of $450.

Where the dollar amount of one entry has been determined in block 120 to be equal to zero minus the dollar amount of another data entry with the same data keys, those date entries are considered cleared or reconciled and can be marked as such. This is indicated in block 124 of FIG. 1, and illustrated in the “CLEARED” column of the summary data table of FIG. 7 for lines 001, 003, 005, 008, 011, and 015. For those entries marked as reconciled, a clearing document number is assigned for tracking purposes. One clearing document number is used for each set of reconciled entries having the same first data key and the same second data key. The clearing document is illustrated in column “CLEARING DOC” of FIG. 7.

Where it is determined in block 120 that a particular entry does not have a corresponding entry with the same data keys and which is equal to zero minus the dollar amount of the particular data entry, then the entry without the match would typically be manually reviewed and fixed as necessary. This is indicated in block 122 of FIG. 1. This allows possible errors to be identified and investigated. For example, if the summary data table contains a data entry from the ordering system for a customer charge but does not contain a corresponding data entry from the customer payment processing system, this may indicate that the customer's credit card payment was not properly processed. This error could be remedied by processing an appropriate payment through the customer payment processing system. When this payment later appears in a financial data table from the customer payment processing system, the two entries will match and can be reconciled. Similarly, two data entries which might otherwise match might have a small dollar amount discrepancy, due perhaps to a rounding error. Such an error could be reviewed and remedied by changing the dollar amount of one of the entries, thus causing the two entries to match and to be reconciled.

For those entries that have been marked as reconciled in block 124, the final step in this process is typically to export the reconciled entries to a general ledger program. It should be appreciated that, in addition to exporting the reconciled entries, the P&L entries, which are typically not reconciled, are also exported to the general ledger. It should also be appreciated that the non-reconciled entries would also typically be exported to the general ledger program. However, continued attempts would typically be made to reconcile the non-reconciled entries.

FIG. 8 is a schematic block diagram of a system for reconciling financial data from a plurality of sources, according to one embodiment of the present invention. FIG. 8 illustrates a system of the present invention using a client/server configuration. The exemplary system of FIG. 8 comprises a server 808 and a client 832. The server 808 comprises a processing element 818, an order data feed 810, a booking data table 812, a vendor payment data table 814, a customer payment data table 816, a cross-reference table 824, and a summary data table 828. In this embodiment, the order data feed 60 is received as XML messages from an ordering system 800. The booking data table 812, the vendor payment data table 814, and the customer payment data table 816 each receive financial data tables from a booking system 802, a vendor payment processing system 804, and a customer payment processing system 806, respectively. It should be appreciated that ordering system 50 could send a data table, similar to the data tables from the booking system, the vendor payment system, and the customer payment system. Similarly, the booking system, the vendor payment system, and the customer payment system could send a data feed similar to the ordering system 50. Processing element 818 receives the financial data feed 810 and the financial data tables from the booking data table 812, the vendor payment data table 814, and the customer payment data table 816. After receiving the financial data feed and the data tables, the processing element 818 parses the financial data using a parsing element 820. The processing element then uses a rules engine 822, which interfaces with the cross-reference table 824 to add the first and second data keys, as discussed in detail above. The processing element 818 then combines the financial data tables into a summary data table and reconciles the data entries using the summarization/reconciliation element 826. The summarized data may be stored in the summary data table 828 prior to being reconciled. After summarization, both the reconciled data and the unreconciled data may be transmitted to the general ledger 830. The client 832 may access the data in the processing element 818 for various administrative purposes, such as manually reviewing data entries as discussed in blocks 112 and 122 of FIG. 1.

While FIG. 8 illustrates a system of the present invention using a client/server configuration, it should be appreciated that the client/server configuration is shown for example purposes only and that they system of the present invention could utilize configurations other than client/server. It should also be appreciated that the overall system architecture shown in FIG. 8 is for example purposes only, and not intended to limit the scope of the present invention. The system of the present invention could be implemented using a number of different system configurations.

The method of reconciling financial data from multiple sources may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIG. 1 is a flowchart of methods and program products according to the invention. It will be understood that each step of the flowchart, and combinations of steps in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of reconciling financial data relating to a plurality of financial transactions from a plurality of sources comprising:
receiving a plurality of financial data tables from a plurality of sources, each financial data table comprising a plurality of data entries and a plurality of data field names, each data entry comprising at least a dollar amount;
formatting the financial data tables such that the financial data tables are capable of being combined;
adding a first data key value and a second data key value to each data entry of each financial data table;
combining the financial data tables into a summary data table, the summary data table comprising a plurality of data entries and a plurality of data field names; and
identifying a first data entry and a second data entry, such that the first data key value of the first data entry equals the first data key value of the second data entry, and such that the second data key value of the first data entry equals the second data key value of the second data entry, and such that the dollar amount of the first data entry equals zero minus the dollar amount of the second data entry.

2. The method of claim 1, further comprising transmitting the identified first data entry and second data entry to a general ledger

3. The method of claim 1, wherein the plurality of sources comprise ordering system, booking system, vendor payment processing system, and customer payment processing system.

4. The method of claim 1, wherein formatting the financial data tables comprises translating at least one of the data field names of at least one of the financial data tables using a rules engine such that the data field names of the financial data tables match the corresponding data field names of the summary data table.

5. The method of claim 4, wherein the plurality of data entries of the financial data tables each have a format, wherein the plurality of data entries of the summary data table each have a format, and wherein formatting the financial data tables further comprises translating at least one of the data entries of at least one of the financial data tables using the rules engine such that the formats of the data entries of the financial data tables matches the format of the corresponding data entries of the summary data table.

6. The method of claim 1, wherein the first data key value is selected from a plurality of general ledger account numbers using general accounting principles and wherein the second data key value is selected to identify one of the plurality of financial transactions.

7. The method of claim 1, wherein each financial data table comprises at least one credit and at least one debit related to each of the plurality of financial transactions, and wherein the method further comprises verifying that the at least one credit equals the at least one debit.

8. A system for reconciling financial data relating to a plurality of financial transactions from a plurality of sources comprising:
a processing element capable of receiving a plurality of financial data tables from a plurality of sources, each financial data table comprising a plurality of data entries and a plurality of data field names, each data entry comprising at least a dollar amount; the processing element further capable of formatting the financial data tables such that the financial data tables are capable of being combined; the processing element further capable of adding a first data key value and a second data key value to each entry of each financial data table; the processing element further capable of combining the financial data tables into a summary data table, the summary data table comprising a plurality of data entries and a plurality of data field names; and the processing element further capable of identifying a first data entry and a second data entry, such that the first data key value of the first data entry equals the first data key value of the second data entry, and such that the second data key value of the first data entry equals the second data key value of the second data entry, and such that the dollar amount of the first data entry equals zero minus the dollar amount of the second data entry.

9. The system of claim 8, wherein the processing element is further capable of transmitting the identified first data entry and second data entry to a general ledger.

10. The system of claim 8, wherein the plurality of sources comprise ordering system, booking system, vendor payment processing system, and customer payment processing system.

11. The system of claim 8, further comprising a rules engine, wherein the processing element is further capable of translating at least one of the data field names of at least one of the financial data tables using the rules engine such that the data field names of the financial data tables match the corresponding data field names of the summary data table.

12. The system of claim 11, wherein the plurality of data entries of the financial data tables each have a format, wherein the plurality of data entries of the summary data table each have a format, and wherein the processing element is further capable of translating at least one of the data entries of at least one of the financial data tables using the rules engine such that the format of the data entries of the financial data tables matches the format of the corresponding data entries of the summary data table.

13. The system of claim 8, wherein the first data key value is selected from a plurality of general ledger account numbers using general accounting principles and wherein the second data key value is selected to identify one of the plurality of financial transactions.

14. The system of claim 8, wherein each financial data table comprises at least one credit and at least one debit related to each of the plurality of financial transactions, and wherein the processing element is further capable of verifying that the at least one credit equals the at least one debit.

15. A computer program product for reconciling financial data relating to a plurality of financial transactions from a plurality of sources, the computer program product comprising at least one computer-readable storage medium having computer-readable program code portions stored therein, the computer-readable program code portions comprising:
a first executable portion capable of receiving a plurality of financial data tables from a plurality of sources, each financial data table comprising a plurality of data entries and a plurality of data field names, each data entry comprising at least a dollar amount;
a second executable portion capable of formatting the financial data tables such that the financial data tables are capable of being combined;
a third executable portion capable of adding a first data key value and a second data key value to each data entry of each financial data table;
a fourth executable portion capable of combining the financial data tables into a summary data table, the summary data table comprising a plurality of data entries and a plurality of data field names; and
a fifth executable portion capable of identifying a first data entry and a second data entry, such that the first data key value of the first data entry equals the first data key value of the second data entry, and such that the second data key value of the first data entry equals the second data key value of the second data entry, and such that the dollar amount of the first data entry equals zero minus the dollar amount of the second data entry.

16. The computer program product of claim 15, further comprising:
a sixth executable portion capable of transmitting the identified first data entry and second data entry to a general ledger.

17. The computer program product of claim 15, wherein the plurality of sources comprise ordering system, booking system, vendor payment processing system, and customer payment processing system.

18. The computer program product of claim 15, wherein the second executable portion is further capable of translating at least one of the data field names of at least one of the financial data tables using a rules engine such that the data field names of the financial data tables match the corresponding data field names of the summary data table.

19. The computer program product of claim 18, wherein the plurality of data entries of the financial data tables each have a format, wherein the plurality of data entries of the summary data table each have a format, and wherein the second executable portion is further capable of translating at least one of the data entries of at least one of the financial data tables using the rules engine such that the format of the data entries of the financial data tables matches the format of the corresponding data entries of the summary data table.

20. The computer program product of claim 15, wherein the first data key value is selected from a plurality of general ledger account numbers using general accounting principles and wherein the second data key value is selected to identify one of the plurality of financial transactions.

21. The computer program product of claim 15, wherein each financial data table comprises at least one credit and at least one debit related to each of the plurality of financial transactions, and wherein the computer program product further comprises a seventh executable portion capable of verifying that the at least one credit equals the at least one debit.
